(19) United States
(12) Patent Application Publication
(10) Pub. No.: US 2012/0072820 A1
(43) Pub. Date: Mar. 22, 2012

(54) Systems and Computer Program Products for Conducting Multi-Window Multi-Aspect Processing and Calculations

(76) Inventor: Joseph Bernard Weinman, JR., Basking Ridge, NJ (US)

(21) Appl. No.: 12/885,526

(22) Filed: Sep. 19, 2010

(51) Int. Cl. G06F 17/00

(52) U.S. Cl. 715/219

(57) ABSTRACT

A data processing system comprises an object manager maintaining two or more uniquely named objects in an object repository, each of the two or more uniquely named objects comprising at least a formula and a value, the value being determined by the formula, a graphical user interface displaying two or more windows, each of the two or more windows corresponding to exactly one named object of the two or more uniquely named objects and displaying within the each window one or more of the name, formula, and value associated with the exactly one named object, and a calculation engine for determining the value of each object responsive to changes in the formula or value of any of the two or more uniquely named objects.

### BACKGROUND

The present disclosure relates generally to the field of programming languages, visual interfaces, and spreadsheets, and, more particularly, to systems and computer program products for conducting multi-window multi-aspect processing and calculations.

Spreadsheets are often used for everything from home finance, to analysis and charting, to complex business financials. Typically, a software program enables manipulation of “workbooks,” which comprise one or more spreadsheets. Each spreadsheet is a single window with a two-dimensional matrix of cells, with each cell identified by a row number (1, 2, 3, 4) and column identifier (“A,” “B,” “C,” etc.). The top left cell is then A1, the one below it A2, the one to the right of the top left cell is B1, and so forth.

Each cell specifies a value, either directly, such as “12” or “George Washington;” via a formula, e.g., “=(3+5)*2;” and/or via reference to other cells, e.g., “=3+A1)*A2.” Additionally, functions such as “square root” typically exist. Although a cell may be identified by its location, its location is not its “name,” as values and formulas may be moved to other locations via cut and paste operations and other values and formulas moved to the cell.

Also, a broad variety of programming languages exist. Historically, these were alphanumeric text-based, such as FORTRAN and C, and enabled specification of algorithms or heuristics for calculation by enabling declaration of variables (“INTEGER n; SINGLE alpha;”) as well as operators such as assignment (“alpha=n+3.1415”) and constructs or compound statements such as “IF condition THEN conditionally-executed-code” or “WHILE condition DO conditionally-repeated-code.” So-called “Visual” programming languages have arisen, for example, Visual Basic from the Microsoft Corporation of Redmond, Wash., which link visual objects such as “buttons” and “drop-down boxes” through an event handler to specific code, thereby enabling construction of software with visual interfaces, such as text editors, browsers, and the like.

Spreadsheets are easy to use, but forcing all calculations and variables into a two-dimensional matrix can be challenging, and referring to data via cell identifiers such as “A1” or “ZZ273” or via ranges of cells such as “QQ37:QZ142” can be confusing and error prone. Moreover, subtleties such as that “B1+C2/5” is merely a random 7-character text string whereas “=B1+C2/5” is a command specifying that the cell's value be set to the value of cell C2 divided by 5 plus the value of cell B1 cause errors as well.

Programming languages, on the other hand, can be somewhat difficult for novices to use, with the potential for syntax or semantic errors due to their flexibility.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the disclosure.

Some embodiments provide a system of processing data comprising an object manager maintaining two or more uniquely named objects in an object repository, each of the two or more uniquely named objects comprising at least a formula and a value, the value being determined by the formula, a graphical user interface displaying two or more windows, each of the two or more windows corresponding to exactly one named object of the two or more uniquely named objects and displaying within the each window one or more of the name, formula, and value associated with the exactly one named object, and a calculation engine for determining the value of each object responsive to changes in the formula or value of any of the two or more uniquely named objects.

Other embodiments provide a system of processing data comprising a controller, a user interface manager, an object manager, an object repository maintaining two or more objects, a calculation engine, one or more input devices, one or more output devices, and a compute and storage environment, the user interface manager displaying two or more of the two or more objects each in its own window, each of the two or more objects comprising one or more aspects, the user interface manager displaying at least one aspect of the one or more aspects for two or more of the two or more objects in the object repository.

Still other embodiments further comprise one or more aspects which may comprise name, value, formula/function, type, graphical control, or style attributes.

In other embodiments, an article of manufacture comprises a non-transitory computer readable storage medium having computer readable program code embodied therein. The computer readable program code comprises computer readable program code configured to control operation, computer readable program code configured to interface with one or more user input devices and one or more user output devices, computer readable program code configured to manage two or more named objects each of said named objects having one or more aspects, computer readable program code configured to update one or more aspects of the one or more named objects based on user commands initiated by the one or more user input devices, computer readable program code configured to display one or more aspects of the one or more named objects via two or more windows with each of the two or more windows uniquely corresponding to a named object of the one or more named objects, computer readable program code configured to create, read, and update the one or more aspects of the named objects on the non-transitory computer readable storage medium, and computer readable program code configured to update one or more aspects of the named objects responsive to updates to one or more aspects of the named objects.

In still other embodiments, the one or more aspects comprise name, value, formula/function, type, graphical control, or style attributes.

Other methods, systems, devices, appliances, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of exemplary embodiments will be more readily understood from the following detailed description of specific embodiments thereof when read in conjunction with the accompanying drawings, in which:

FIG. 1 is a block diagram that illustrates multiple windows and multiple aspects for viewing and specifying processing and calculations in accordance with some embodiments;

FIG. 2 is a diagram that illustrates systems and computer program products for multi-window multi-aspect processing and calculations in accordance with some embodiments.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Exemplary embodiments may be embodied as methods, systems, and/or computer program products. Accordingly, exemplary embodiments may be embodied in hardware and/or in software (including firmware, resident software, micro-code, etc.). Furthermore, exemplary embodiments may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Some embodiments described herein may provide systems and computer program products for performing multi-window multi-aspect processing and calculations. Objects such as variables and functions each may be mapped to a “window.” Such a window in practice depends on the specific operating environment in use. For example, in some versions of the “Windows” operating system from Microsoft Corp. of Redmond, Wash., such a window may be a multiple-document interface (MDI) child, further comprising elements such as Picture Boxes and Text Boxes. In an HTML browser environment, such a window may be an absolute-positioned or relative-positioned “div” element comprising html text, anchors, and the like. Such windows may overlap, with ordering specified in the z dimension, or may be laid out in one, two or more dimensions. In any event, each window corresponds to a named object which may be a variable, constant, or function. At any given time, no, one, several, or all windows and thus objects may be visible.

Each window may display one or more aspects of the object, such as its name, its value, its data type (e.g., integer, single precision floating point, array, Boolean), its allowed values, error checking, its enumeration range, a formula or complex set of functions, a user input widget such as a slider bar, or dependent graphical elements such as slider bar illustrating a value or a chart such as a bar chart or pie chart. An object may itself be a spreadsheet, that is, a two-dimensional array of values and formulas, which may be either referenced as a spreadsheet object and specific cells (e.g., Spread!B1) or as a two-dimensional array (e.g., Spread[4,7]). Another aspect may be style elements such as top, left, height, width, background-color, or the like. Another aspect may be a Uniform Resource Locator or Identifier where the object may be found over a network such as the Internet. Thus, data residing on other systems, either openly available or secured via an Intranet, VPN, secure sockets, or the like, may be utilized in the calculations. Such data may organized as html with a document object model, xml, databases, flat files, or the like. Generally speaking, users specify variables, constants, and functions which may refer to other variables, constants, or functions to specify and manipulate how processing or calculations may be conducted.

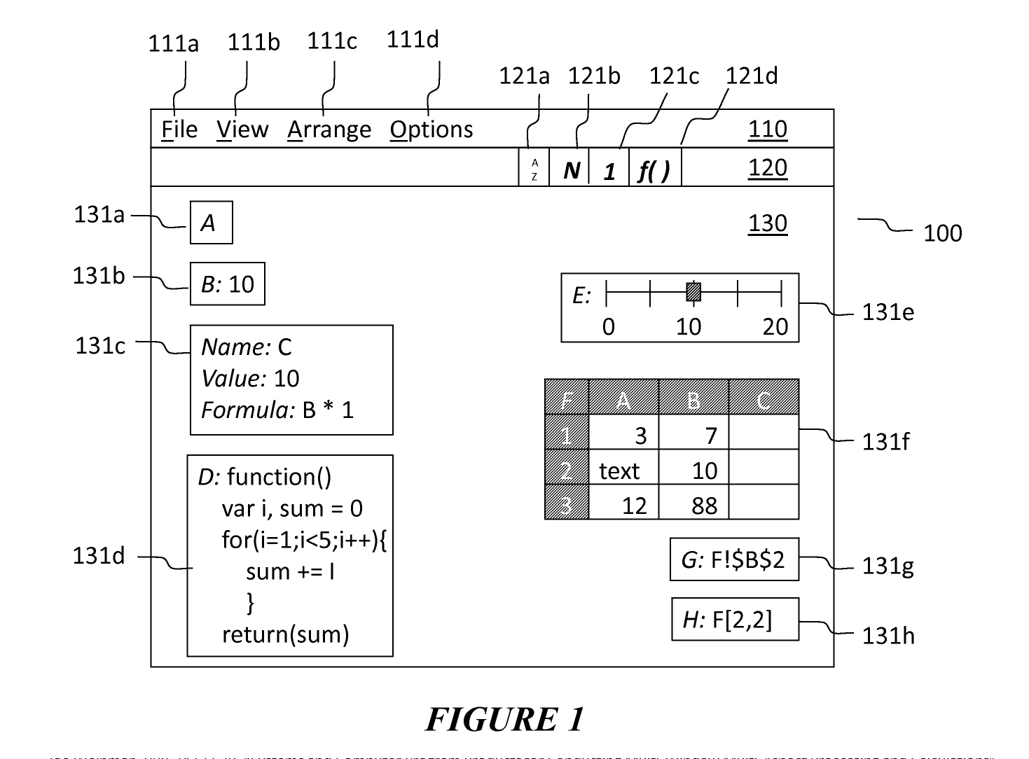

FIG. 1 is a block diagram of a user interface 100 with multiple windows and multiple aspects for viewing and specifying processing and calculations in accordance with some embodiments. The user interface 100 comprises a multi-window, multi-aspect object manipulation area 130, and may comprise a command bar 110 and a tool bar 120.

Command bar 110 may comprise commands and subcommands such as file commands 111a which enable information to be saved, retrieved, printed, imported, exported, or the like. Command bar 110 may also comprise view commands 111b which enable object windows to be displayed, hidden, or unhidden, and which enable various aspects to be highlighted for one or more windows, such as show names only, show values only, show formulas only, show other aspects only, or show various combinations of these. Command bar 110 may also comprise arrange commands 111c which allow object windows to be arranged in various orders or layouts, e.g., sorted in ascending or descending order by name, sorted by value, sorted by type, sorted by time of creation, access, or modification, optimally or near-optimally tiled, and the like. Command bar 110 may also comprise other options commands 111d which may include spell check, link check, help, on-line help, and so forth. It will be appreciated that the existence of and exact groupings of specific commands may vary substantially from that described herein, and may be user or administrator specified.

Tool bar 120 may comprise specific buttons that either directly cause actions or further enable specification of actions via dialog boxes, drop down boxes, further tool bars, or other means as are known in the art. Tool bar 120 may comprise buttons such as a sort button 121a, a show names aspect button 121b, a show values aspect button 121c, a show functions aspect button 121d, and the like, which may be used singly or in combination to selectively control display of one or more of the multiple aspects of each object.

Object manipulation area 130 provides the means to view and edit one or more aspects of one or more objects via one or more windows. The exact number of windows shown here is intended to be exemplary, and the number of windows displayed may be lesser or greater and the aspects displayed may vary. As shown here, however, window 131a displays the name aspect of a variable named “A.” Window 131b displays the name aspect of a variable named “B,” and the value aspect “10” of that variable. Window 131c simultaneously displays the name aspect of a variable named “C,” the value aspect, “10”, and a formula/function aspect specifying that the value of C is to be determined by multiplying the value of the variable “B” by the number 1. We use terms such as “B,” the variable “B,” the object “B,” the object named “B,” and the object with name aspect “B” interchangeably. Window 131d displays the name aspect of a variable named “D,” and a formula/function aspect specifying that the value of D is to be determined by conducting a series of calculations as defined primarily be a for loop. We use formula and function or formula/function somewhat interchangeably as a means for determining a value based on other values, where a formula is a function that is simple enough to express in a single statement, whereas a function requires multiple statements which may be assignment, conditional execution, iteration or similar complex structures. Window 131e provides a graphical means for both viewing and setting the value of a variable E, currently set to “10.” Window 131f displays the name aspect of an object named “F,” and the data and/or formulas comprising the object named “F,” which is a two-dimensional array that is a spreadsheet with multiple values. Window 131g displays an object named “G,” together with the formula/function for calculating G via a reference to a cell in F. Window 131 h displays the name of an object named “H,” together with the formula/function for calculating H based on reference to a cell in F. It will be appreciated that reference to the aspects illustrated here are not intended to be limiting. Other aspects may include style attributes such as height, width, color, position, image(s), rotation, contrast, brightness, aspect ratio, slant, skew, etc. Formulas may include these attributes, for example, the height value of object “A” may be set to 12*the width value of object “B” plus the height value of object “C”, with appropriate “handles” being used to graphically adjust the individual objects on screen such that moving or morphing a single object may cause graphical, locational, or other stylistic alterations to one or more other objects.

It will be appreciated that by “window,” we mean an individually controllable screen entity, which typically may be a child of a parent window. Consequently, each object window 131x may be moved within the parent window area, or may be individually minimized or restored. Moreover, each window 131x is capable of overlapping other windows, being overlapped, and displaying either minimal information (for example, a name or a value or even just a color or outline at a location) or substantial information (with some selective means such as zooming, scroll bars, “hands” for dragging position, etc.) of its various aspects, e.g., graphs, full two dimensional arrays of floating point numbers, thousands of lines of code representing a complex function, and the like.

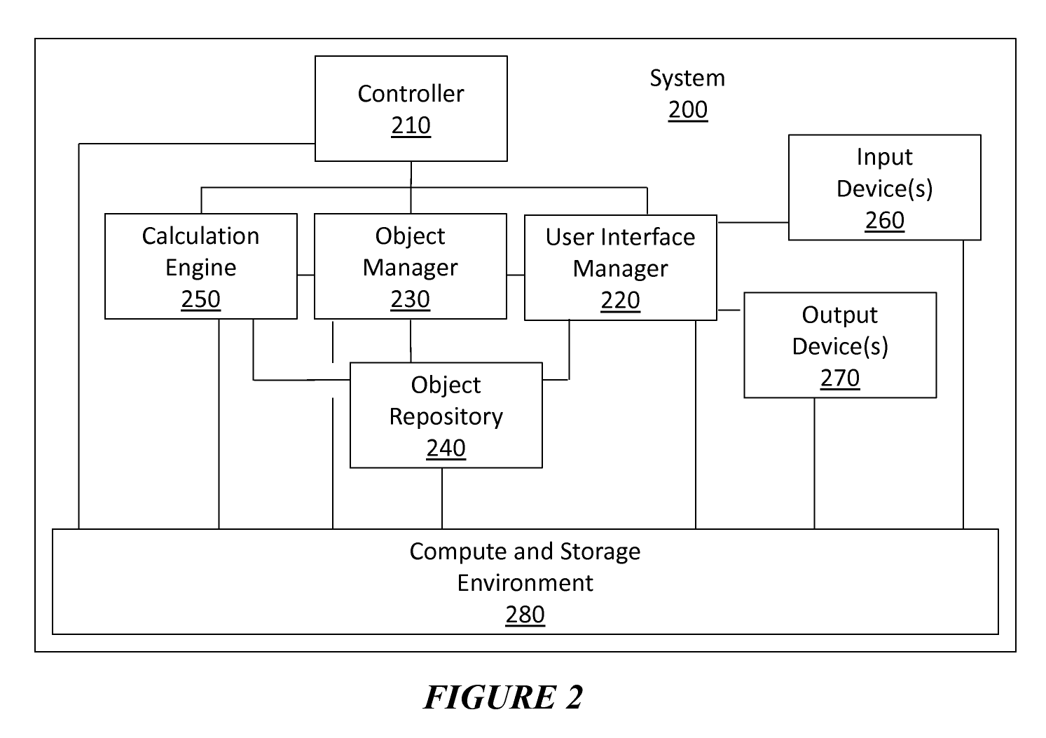

FIG. 2 is a block diagram of a system 200 for conducting multi-window multi-aspect processing and calculations in accordance with some embodiments. System 200 comprises controller 210, user interface manager 220, object manager 230, object repository 240, calculation engine 250, one or more input devices 260, one or more output devices 270, and compute and storage environment 280.

Controller 210 manages the function of elements of system 200, e.g., initiation and termination of processes, repair or resetting of system parameters to default settings, and the like. It may conduct such functions based on an internal timer (not shown) within compute environment 280 or responsive to user input from one or more input devices 260 mediated via user interface manager 220. It may also conduct such actions based on automatic detection of error conditions, such as a corrupted object repository 240.

User interface manager 220 may acquire input such as keystrokes, mouse moves and mouse clicks, touch, multi-touch, acceleration, microphone input, gestures, and so forth from one or more input devices 260. One or more input devices 260 may include touch screens, keyboards, mice, microphones, video cameras, accelerometers, or other input devices as are known in the art. User interface manager 220 also may drive output such as text, screen updates, sounds, video output, and the like via one or more output devices 270, such one or more output devices 270 including graphics displays, projectors, touch screen displays, speakers, vibration modules, and so forth.

User interface manager 220 also handles the display of multiple windows in user interface 100, and the event handling and command mapping due to user inputs such as mouse clicks or keyboard selection of various options in command bar 110 or tool bar 120, or various actions requested in object manipulation area 130, including in-line editing of various aspects of the one or more objects and their corresponding windows 131x, or additional updating functions offered by other components (not shown) such as modal dialogue boxes, pop-up menus, and the like.

Such object aspect updates are implemented via object manager 230, which then updates information associated with such objects in object repository 240. For example, a user may decide that the value aspect of the object with name aspect “D” should be defined by the formula aspect “C*5.” Such an input would be made via one or more input devices 260, handled by user interface manager 220, with object manager 230 then updating appropriate information in object repository 240. Object manager 230 may ensure that the formula aspect is syntactically correct, warning or automatically correcting if not. Object manager 230 may also ensure that the formula or other aspects are semantically valid, for example, ensuring that there is an object with name aspect C, that it has a type aspect that is numeric, and warning or automatically correcting if not.

Object repository 240 may be implemented in a variety of ways. For example, it may be a relational database with one entry (row) for every named object and a pre-defined field for every possible aspect: name, type, value, formula, and the like. Or, object repository 240 may be implemented as a number of key-value pairs for each named object, extensible by the user to other aspects in addition to the ones named here.

Object repository 240 may also manage reference information for each object, e.g., recording not only that the object with name aspect “D” is calculated by multiplying the value aspect of the object with name aspect “C” by the number 5, but also noting under the object named “C” that it is referenced by the object named “D” to speed updates to the value of a dependent variable when an independent variable's value changes.

Calculation engine 250 may recalculate value or style attributes of objects based on changes to object repository 240 made by object manager 230. In the case described above, if the value aspect of the object with name aspect “C” changes to 11, the value aspect of the object with name aspect “D” would change to 55. Similarly, if the height aspect was set to be “C*10” pixels, then the height of the object named “D” would be set to 110 pixels. All components such as controller 210, user interface manager 220, object manager 230, object repository 240, calculation engine 250, one or more input devices 260, and one or more output devices 270, reside on or cooperate with compute and storage environment 280. Such a compute and storage environment 280 may comprise one or more CPUs each with one or more cores, one or more storage devices such as flash drives, solid-state disk drives, hard disk drives, storage networks, optionally a hypervisor, one or more operating systems, clustering software, load balancers, network elements, and the like as are known in the art. Such implementation details are not intended to be limiting, but rather exemplify the elements and capabilities of a dedicated, purpose-built or general purpose computing infrastructure.

Although FIGS. 1 and 2 illustrate an exemplary system for performing multi-window multi-aspect processing and calculations in accordance with some embodiments, it will be understood that embodiments of the present invention are not limited to such configurations, but are intended to encompass any configuration capable of carrying out the operations described herein.

Computer program code for carrying out operations of data processing systems discussed above with respect to FIGS. 1 and 2 may be written in a high-level programming language, such as Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. Embodiments described herein, however, are not limited to any particular programming language. It will be further appreciated that the functionality of any or all of the program modules may also be implemented using discrete hardware components, one or more application specific integrated circuits (ASICs), or a programmed digital signal processor or microcontroller.

Exemplary embodiments are described herein with reference to flowchart and/or block diagram illustrations of methods, systems, and computer program products in accordance with exemplary embodiments. These flowchart and/or block diagrams further illustrate exemplary operations for performing homomorphic encryption and decryption on individual operations, in accordance with some embodiments. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

Many variations and modifications can be made to the preferred embodiments without substantially departing from the principles of the present invention. All such variations and modifications are intended to be included herein within the scope of the present invention, as set forth in the following claims.

That which is claimed:

1. A data processing system, comprising:
an object manager maintaining two or more uniquely named objects in an object repository;
each of the two or more uniquely named objects comprising at least a formula and a value, the value being determined by the formula;
a graphical user interface displaying two or more windows;
each of the two or more windows corresponding to exactly one named object of the two or more uniquely named objects and displaying within the each window one or more of the name, formula, and value associated with the exactly one named object;
a calculation engine for determining the value of each object responsive to changes in the formula or value of any of the two or more uniquely named objects.

2. A data processing system, comprising:
a controller, a user interface manager, an object manager, an object repository maintaining two or more objects, a calculation engine, one or more input devices, one or more output devices, and a compute and storage environment;
the user interface manager displaying two or more of the two or more objects each in its own window;
each of the two or more objects comprising one or more aspects;
the user interface manager displaying at least one aspect of the one or more aspects for two or more of the two or more objects in the object repository.

3. The data processing system of claim 2, wherein the one or more aspects comprise name, value, formula/function, type, graphical control, or style attributes.

4. An article of manufacture, comprising:
a non-transitory computer readable storage medium having computer readable program code embodied therein, the computer readable program code comprising:
computer readable program code configured to control operation;
computer readable program code configured to interface with one or more user input devices and one or more user output devices;
computer readable program code configured to manage two or more named objects each of said named objects having one or more aspects;
computer readable program code configured to update one or more aspects of the one or more named objects based on user commands initiated by the one or more user input devices;
computer readable program code configured to display one or more aspects of the one or more named objects via two or more windows with each of the two or more windows uniquely corresponding to a named object of the one or more named objects;
computer readable program code configured to create, read, and update the one or more aspects of the named objects on the non-transitory computer readable storage medium;
computer readable program code configured to update one or more aspects of the named objects responsive to updates to one or more aspects of the named objects.

5. The article of manufacture of claim 4, wherein the one or more aspects comprise name, value, formula/function, type, graphical control, or style attributes.
